(19) United States
(12) Patent Application Publication
(10) Pub. No.: US 2026/0192773 A1
(43) Pub. Date: Jul. 9, 2026

(54) SEATBELT RETRACTOR AND VEHICLE SEAT

(71) Applicant: Autoliv Development AB, Vargarda (SE)

(72) Inventors: Arndt SÖHNCHEN, Hamburg (DE); Alexandru CIRSTEA, Elmshorn (DE); Antto-Christian GLAESSER, Mömbris (DE)

(21) Appl. No.: 19/134,995

(22) PCT Filed: Nov. 30, 2023
(86) PCT No.: PCT/EP2023/083733

§ 371 Date: Jun. 2, 2025

(30) Foreign Application Priority Data
Dec. 5, 2022 (DE) 10 2022 132 184.3

(51) Int. Cl. B60R 22/26; B60R 22/18; B60R 22/34

(52) U.S. Cl. CPC B60R 22/26; B60R 22/34; B60R 2022/1818

(57) ABSTRACT

The invention relates to a seatbelt retractor for securing in and/or on a backrest of a vehicle seat, wherein the seatbelt retractor has a housing in which a belt shaft is rotatably mounted about an axis of rotation, on which a seatbelt of the seatbelt retractor is wound to form a cylindrical belt winding The housing comprises two housing halves which at least partially radially surround the belt winding, wherein at least one other functional module of the seatbelt retractor is arranged in the housing along the axis of rotation of the belt shaft. The invention also relates to a corresponding vehicle seat

The present invention relates to a seatbelt retractor having the features of the preamble of claim 1 and to a vehicle seat having the features of the preamble of claim 15.

Restraint devices for motor vehicles comprise not only airbags but also seatbelt devices, which directly restrain the occupant via a seatbelt. The seatbelt device can be designed as a 3-point belt, for example. In this case, one end of the seatbelt can be wound onto a belt shaft of a seatbelt retractor that can be locked in the pull-out direction, and the other end is secured to the vehicle via an end fitting. Furthermore, the seatbelt has a belt tongue which can be locked in a belt buckle secured to the vehicle and which, in the locked position, divides the belt webbing of the seatbelt into a diagonal belt portion crossing the occupant's chest and a lap belt portion crossing the occupant's pelvis. If the seatbelt device is designed as a 2-point belt or a 4-point belt, the free ends can instead also be directly locked in a belt buckle secured to the vehicle by means of a belt tongue.

The restraint forces to be applied in the event of an accident are then transmitted from the seatbelt, via the connecting points attached to the vehicle, i.e., the seatbelt retractor, the end fitting and/or the belt buckle, and into the vehicle structure so that these parts themselves and the manner in which they are secured to the vehicle structure must be designed to be correspondingly load-bearing. Furthermore, it may be necessary for the seatbelt to be deflected as it passes out of the belt shaft of the seatbelt retractor so that it is fed at an angle that is advantageous for restraining the occupant. The same problem arises if the seatbelt retractor is to be secured to a specific point for space reasons and the seatbelt has to be fed over a longer distance before it is deflected and guided to the occupant.

From this point of view, seat-integrated seatbelt devices, such as those provided in vehicle seats of convertibles, rotating seats or bench seats, pose a particular problem. The problem with such seat-integrated seatbelt devices is the very limited space available in the vehicle seat. In addition, the restraining forces from the seatbelt retractor must be transmitted to the vehicle seat and therefore correspondingly dimensionally stable connecting points have to be provided on the vehicle seat, which complicates the possible mechanical connection of a seatbelt retractor. This applies in particular to vehicle seats in which the seatbelt retractor is not designed as an integral part of the vehicle seat, or to vehicle seats which are designed as bench seats, i.e., for example 2 or 3 seats next to one another.

Against this background, the object addressed by the invention is to specify a seatbelt retractor for a vehicle seat and a vehicle seat comprising such a seatbelt retractor, which allow the seatbelt retractor to be mounted on or in a vehicle seat in a simple manner.

In order to achieve the object, a seatbelt retractor having the features of claim 1 and a vehicle seat having the features of claim 15 are proposed. Further preferred embodiments and developments can be found in the de-pendent claims, the drawings and the associated description.

To achieve the object, a seatbelt retractor is proposed for securing in and/or on a backrest of a vehicle seat, wherein the seatbelt retractor comprises a housing in which a belt shaft is mounted so as to be rotatable about an axis of rotation. A seatbelt of the seatbelt retractor can be wound onto the belt shaft to form a cylindrical belt winding, wherein the housing comprises two housing halves which at least partially radially surround the belt winding, wherein at least one other functional module of the seatbelt retractor is arranged in the housing along the axis of rotation of the belt shaft, preferably coaxially to the axis of rotation.

The proposed arrangement makes it possible to achieve a seatbelt retractor with a very small cross-sectional area perpendicularly to the winding axis of the belt shaft so that when the seatbelt retractor is integrated into a backrest, the space available in a vehicle seat can be used as best as possible. This means that, for example, additional forms or thicker versions of a backrest for accommodating a seatbelt retractor are not necessary. By arranging additional functional modules, such as belt tensioners and pre-tensioners, along the axis of rotation, for example coaxially to the axis of rotation, it is possible to reduce the circumference of the seatbelt retractor around the winding axis to the size necessary to accommodate the belt winding or the wound-up seatbelt.

According to a development, it is proposed that at least one housing half has, radially towards the outside, at least one partially cylindrical bulge, which is adapted to the belt winding.

This allows large portions of the seatbelt retractor to be even narrower as it extends along the axis of rotation, with the seatbelt retractor only having a larger width in the belt winding portion in order to accommodate the wound-up seatbelt. This allows a larger volume to be provided in the backrest of a vehicle seat, for example for the installation of seat cushions or seat adjustment motors. Preferably, both housing halves have, radially towards the outside, partially cylindrical bulges. The bulge on one or both of the housing halves is preferably adapted to the contour of the belt winding so that the housing can be widened to the smallest possible extent in order to accommodate the belt winding.

In advantageous embodiments, the housing forms a cuboidal interior, which is enlarged by the bulges. The cuboidal interior between the housing halves serves to accommodate, hold and protect the additional functional modules of the seatbelt retractor. Additionally, in advantageous embodiments, the cuboidal interior does not have an ideal cuboid shape, but the cuboidal interior preferably has beads and/or rounded or chamfered corners and/or edges.

It is further proposed that the seatbelt retractor has a bearing plate along the axis of rotation on both sides of the belt winding, each of which engages in at least one housing half. The bearing plates are designed to absorb the bearing forces of the belt shaft and introduce them to the housing halves. The absorbed forces can be transmitted from at least one housing half to a backrest of a vehicle seat.

Preferably, one of the bearing plates divides the interior of the housing into a belt winding chamber and a functional chamber, wherein the belt winding chamber and the functional chamber are arranged one behind the other along the axis of rotation of the belt shaft. The belt shaft is preferably guided through the bearing plate from the belt winding chamber to the functional chamber. By separating the housing interior into the belt winding chamber and the functional chamber, the rigidity of the housing and the rigidity with which the belt shaft is mounted can be increased. Furthermore, the entrance of potential foreign bodies along the belt path of the seatbelt can be limited to the belt winding chamber of the seatbelt retractor.

Preferably, the housing has beads extending in parallel with the axis of rotation of the belt shaft. These beads make the housing more rigid and can also improve the support of the bearing plates. This can, for example, result in improved contact between a bearing plate and the housing together with optimized force transmission.

In preferred embodiments, the housing has beads arranged in a cross shape, preferably in the region of the functional chamber. The cross-shaped beads can also make the housing more rigid in the housing region. This allows, among other things, the torsional behavior and torsional rigidity of the housing to be improved, which is particularly advantageous especially for the coaxial arrangement of the belt shaft and functional elements with a housing that is very long by comparison.

According to a development, it is proposed that the housing comprises mounting portions and interior portions which form an interior, wherein the mounting portions are flat and adjoin parts of the interior portions. Preferably, at least one housing half of the housing comprises mounting portions and interior portions that are integral. The mounting portions therefore do not form a boundary for the interior of the seatbelt retractor, but serve to install and secure it in and/or on the backrest of a vehicle seat. One or both housing halves is/are preferably made of sheet metal.

According to a development, it is proposed that the mounting portions lie in a common securing plane. Therefore, for example, the mounting portions in the form of flat portions of one or both housing halves can preferably be located on both sides of the axis of rotation of the belt shaft in the common securing plane. This allows the seatbelt retractor to be easily mounted and secured to and/or in a backrest of a vehicle seat.

According to an advantageous development, it is proposed that the mounting portions lie in the securing plane together with an interior portion. For example, one housing half can be plate-shaped, with a middle part forming an interior portion, for example, which mounting portions adjoin on two or more sides, wherein the interior portion and the mounting portions lie in the securing plane so that this interior portion can also rest against the rear of a vehicle seat.

In advantageous embodiments, the mounting portions are formed in a single layer from one housing half or in two layers from two housing halves. Accordingly, said seatbelt retractor can be secured to and/or in a backrest of a vehicle seat via one or both housing halves. Double-layer mounting portions consisting of two housing halves are particularly advantageous because the forces from the belt shaft can be directly transferred to a backrest via the two housing halves. Furthermore, the double-layer mounting portions with both housing halves can enable the housing to be closed by a simple force fit, allowing the process of securing the seatbelt retractor and transmitting forces between the two housing halves to be integrated with one another.

In advantageous embodiments, the mounting portions have at least one interruption along the axis of rotation of the belt shaft. This allows the weight of the seatbelt retractor to be reduced and can make it easier to secure it to and/or in a vehicle seat.

It is further proposed that an upper mounting portion is arranged above the interior portion and a lower mounting portion is arranged below the interior portion, wherein the lower mounting portion is wider than the upper mounting portion. The upper mounting portion is preferably located on the side of the outlet opening for the seatbelt, while the lower mounting portion is preferably located on the side remote from the outlet opening. This allows for optimized force flow and thus greater load-bearing behavior. It is particularly advantageous if a securing projection and/or a rivet nut on the lower mounting portion runs in a plane through the center of the belt winding and/or the outlet opening. This can largely avoid the introduction of additional moments when a load is applied, and the forces from the seatbelt can be easily transferred to a seat structure.

According to another development, it is proposed that the seatbelt is guided out of the seatbelt retractor through an outlet opening, wherein at least three securing projections are provided in the mounting portions on the housing of the seatbelt retractor for securing in and/or on a backrest of a vehicle seat.

Securing the seatbelt retractor in and/or on a backrest refers to the orientation and position of the seatbelt retractor housing. For example, when securing the seatbelt retractor to and in a backrest, the securing projections thereof can be located on the back of the backrest, wherein, when securing the seatbelt retractor in a backrest, the housing thereof projects into the backrest from the securing projections, and wherein, when securing the seatbelt retractor to a backrest, the housing thereof projects out of the backrest from the securing projections. The proposed seatbelt retractor therefore also allows for a wide variety of securing options in this regard. The securing projections are preferably located in mounting portions of the housing or in the mounting portion of one or both of the housing halves.

Preferably, the housing halves are connected to one another by means of at least three rivet nuts, wherein the at least three rivet nuts form at least three securing projections for securing in and/or on a backrest of a vehicle seat.

The rivet nuts can be used to create a securing projection on the seatbelt retractor in a simple manner, which enables easy mounting and good force transmission from the securing projection to the housing, in particular to at least two housing halves, of the seatbelt retractor. The housing and the housing halves are preferably made of metal or a metal alloy. Furthermore, the housing halves are preferably sheet metal parts. The housing preferably consists of two shell-and/or cover-like housing halves, which are connected to one another by the slotted nuts, while the rivet nuts simultaneously provide securing projections for securing to a vehicle seat. Preferably, a simple screw connection to secure the seatbelt retractor on and/or in a vehicle seat using the rivet nuts is possible. Due to the securing projections being designed having rivet nuts, the mechanical requirements for the vehicle seat to accommodate the seatbelt retractor are reduced and the number of options for positioning the seatbelt retractor on a vehicle seat are increased.

Preferably, the rivet nuts have a collar which rests on the housing half in the direction of the vehicle seat. The rivet nut is inserted into openings, preferably hexagonal openings, in the housing halves so that the collar of the rivet nut rests against the housing. In this case, the collar can simultaneously serve as a spacer element, preventing the entire surface of housing from resting against the backrest or vehicle seat, thus reducing possible movement noises, such as squeaking, caused by relative movements under load.

In an advantageous embodiment, the housing halves are connected by means of at least one press join.

A clinching press joint is also known as a clinch connection and is particularly suitable for additionally connecting two housing halves made of sheet metal. This can, for example, further increase the rigidity and strength of the housing. The seatbelt retractor preferably has a plurality of press joints or clinch connections. Furthermore, the at least one additional press joint allows the position of the rivet nuts, in the form of securing projections, on the housing of the seatbelt retractor to be particularly freely selected so that a particularly flexible connection is possible. Alternatively or in addition to the press join, other mechanical connections can also be used, such as welding, studs, rivets and/or gluing.

It is further proposed that the housing has two housing halves which are connected to one another by means of at least one lock seam. The lock seam can, for example, extend over the entire length of the edges at the top and/or bottom edge, in particular over the mounting portions. It is also possible in further embodiments that the lock seam extends only over a short portion, e.g., a sub-portion of the edges, in particular the mounting portions.

In further advantageous embodiments, the housing has at least two housing halves which are connected by means of at least one clinch connection and one lock seam, whereby a particularly stable and secure mechanical connection can be achieved.

Preferably, the seatbelt retractor comprises a belt guiding element which is inserted into one housing half of the housing and comprises the outlet opening for the seatbelt.

The belt guiding element preferably closes the housing of the seatbelt retractor to such an extent that only the outlet opening for the seatbelt re-mains. The belt guiding element can be used in particular to prevent dirt from entering the seatbelt retractor. The outlet opening is preferably designed as a tunnel and further preferably has a flat, rectangular cross-sectional area. Furthermore, the outlet opening is preferably tubular, which also makes it more difficult for foreign bodies and dirt to enter. The belt guiding element can be made of plastics, for example, preferably by injection molding.

In advantageous embodiments, the belt guiding element is inserted into the housing half transversely to the exit direction of the seatbelt.

This allows for easy mounting and prevents potential loosening of the belt guiding element when the seatbelt is pulled out or retracted or is under load or said guiding element from also being pulled out together with the seatbelt.

According to a development, it is proposed that the at least three securing projections are located in a common securing plane of the seatbelt retractor.

The common securing plane makes it easier to structurally connect and mount the seatbelt retractor to a backrest of a single vehicle seat or a backrest of a vehicle seat for 2 or 3 people or a vehicle bench seat, in particular a rear bench seat, for several people. Furthermore, it is also easier to structurally connect, mount and secure the seatbelt retractor in such a backrest. Proceeding from the securing plane or from the edges or mounting portions of at least two housing halves, which are preferably connected to one another by the rivet nuts, the housing of the seatbelt retractor can extend either forwards in the direction of an occupant on a vehicle seat or backwards away from an occupant on a vehicle seat.

It is further proposed that the outlet opening for guiding the seatbelt out is configured in parallel with the securing plane. This allows for good force transmission from the seatbelt to a vehicle seat.

Furthermore, in order to achieve the object, a vehicle seat having the features of claim 12 is proposed. A vehicle seat comprising a seatbelt retractor according to any one of claims 1 to 11 is proposed, wherein the vehicle seat has a backrest, wherein the seatbelt retractor is secured in and/or on the backrest.

A corresponding vehicle seat allows the seatbelt retractor to be integrated into a backrest of the vehicle seat, wherein the integration thereof is not limited to securing it to a seat pillar, to an upper cross member of the vehicle seat or as an integral upper cross member of the vehicle seat. Rather, the seatbelt retractor can be largely freely mounted or secured to the backrest in various positions. In possible embodiments, the seatbelt retractor can therefore be mounted on the backrest in various positions and, for example, covered by a cover. In alternative embodiments, the seatbelt retractor can be integrated into the backrest at various points so that the backrest forms a closed surface behind which the seatbelt retractor is embedded. The vehicle seat preferably has securing positions corresponding to the rivet nuts.

Preferably, the outlet opening of the seatbelt retractor is directed upward. Upward refers here to the orientation of the vehicle seat in a vehicle so that the outlet opening preferably points in the direction of the upper end of the backrest. This means the seatbelt is directly pulled out. This allows for easy belt guidance from the belt shaft without deflection, thus enabling easy force transmission in parallel with the backrest and preferably in parallel with a securing plane. The upwardly directed outlet opening is particularly advantageous in particular in combination with the belt guiding element so that par-ticles can be effectively prevented from falling into the seatbelt retractor.

According to an advantageous development, it is proposed that the vehicle seat has a seatbelt deflector, wherein the seatbelt is guided from the seatbelt retractor to the seatbelt deflector in parallel with the backrest. The seatbelt deflector in the vehicle seat is preferably secured on and/or in the backrest sepa-rately from the seatbelt retractor. By separating the seatbelt deflector, for example in order to feed the seatbelt on the front side, and the seatbelt retractor, the largely free positionability of the housing, for example by using the rivet nuts as securing projections, can be utilized particularly effectively. Accordingly, one or more seatbelt retractors can be integrated into a backrest in a space-optimized manner. The seatbelt deflector can, for example, be a ring on the vehicle seat, in particular on the lateral seat structure, and may also have an exit aperture for the seatbelt.

In preferred embodiments, the seatbelt retractor and the seatbelt deflector are spaced apart by more than 10 cm. Accordingly, for typical belt deflection with a seatbelt retractor integrated into the backrest, it is not necessary to secure the seatbelt retractor to the upper end of the backrest. Therefore, the seatbelt retractor can be secured to a lower region of the backrest, allowing the backrest to be flatter in the upper region.

According to a development, it is proposed that the seatbelt is directly guided out of the seatbelt retractor from the belt shaft. Accordingly, no deflection preferably takes place in the seatbelt retractor so that the seatbelt can be guided out of the seatbelt retractor without additional friction caused by a deflection.

In preferred embodiments, the seatbelt retractor and the seatbelt deflector are spaced apart by more than 10 cm. Accordingly, in typical belt guidance with a seatbelt retractor integrated in the backrest, it is not necessary to secure the seatbelt retractor to the upper end of the backrest; instead, the seatbelt retractor can be secured in a lower region of the backrest, which allows the backrest to be flatter in the upper region.

It is further proposed that the seatbelt retractor is arranged in and/or on the backrest in the chest region or in and/or on the backrest in the pelvic region. This allows the seatbelt retractor and the deflection to be functionally separated, which increases the design options of the vehicle seat and re-duces the mechanical requirements on the securing elements of the backrest for interaction with the securing projections of the seatbelt retractor.

In an advantageous embodiment, it is proposed that three seatbelt retractors for three occupants are arranged next to one another on a backrest. This makes it easy to create the backrest of a vehicle bench seat having a plurality of seats with integrated seatbelt retractors.

According to an advantageous embodiment, it is proposed that the housing extends at least over half the width of the backrest of the vehicle seat.

The invention is explained below using preferred embodiments with reference to the accompanying figures, in which:

FIG. 1 is a front view of a seatbelt retractor;

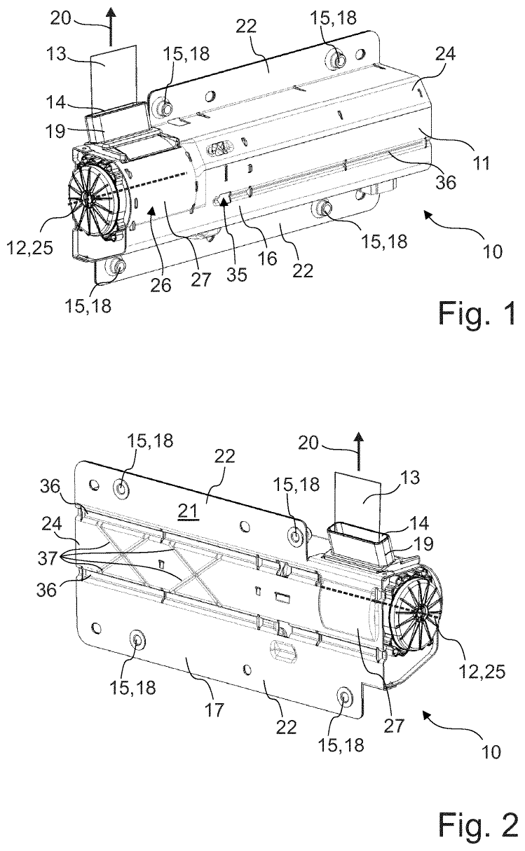

FIG. 2 is a rear view of a seatbelt retractor;

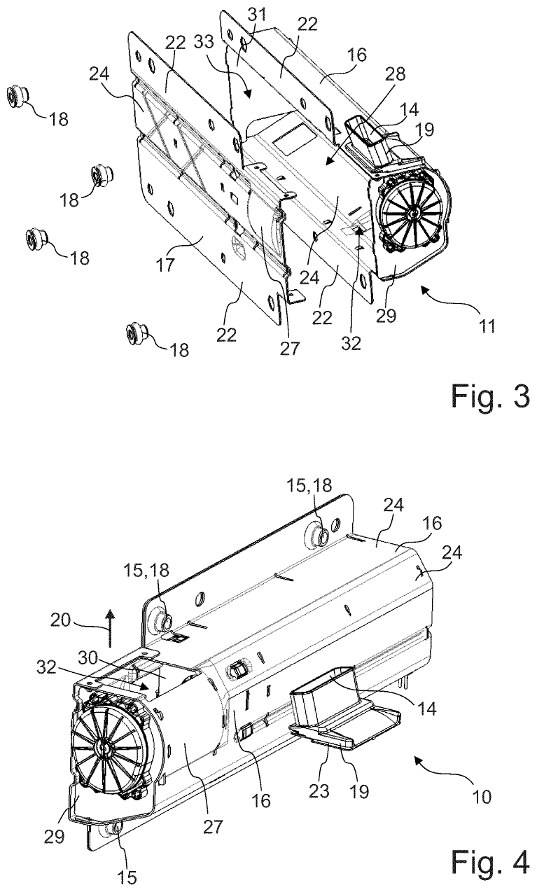

FIG. 3 is an exploded view of a housing of a seatbelt retractor that comprises two housing halves and four slotted nuts;

FIG. 4 is an exploded view of a seatbelt retractor comprising a housing and a belt guiding element;

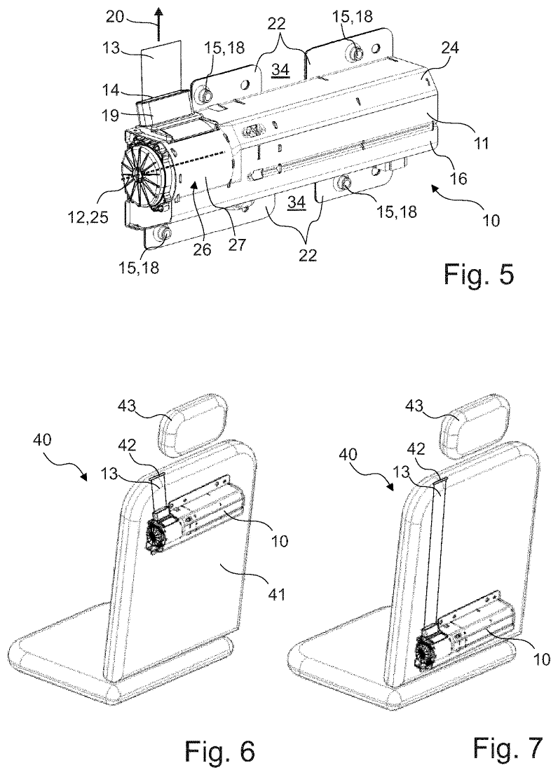

FIG. 5 shows a seatbelt retractor with interruptions in the mounting portion;

FIG. 6 shows a vehicle seat comprising a seatbelt retractor mounted on the backrest at chest height;

FIG. 7 shows a vehicle seat comprising a seatbelt retractor mounted on the backrest at pelvic height;

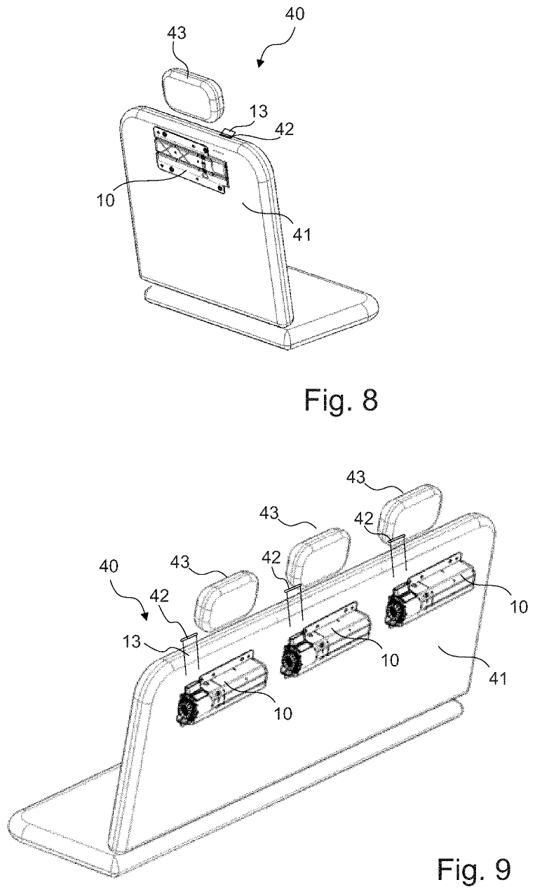

FIG. 8 shows a vehicle seat comprising a seatbelt retractor mounted in the backrest;

FIG. 9 shows a vehicle seat in the form of a vehicle bench seat having three seats and three seatbelt retractors mounted on the backrest at chest height;

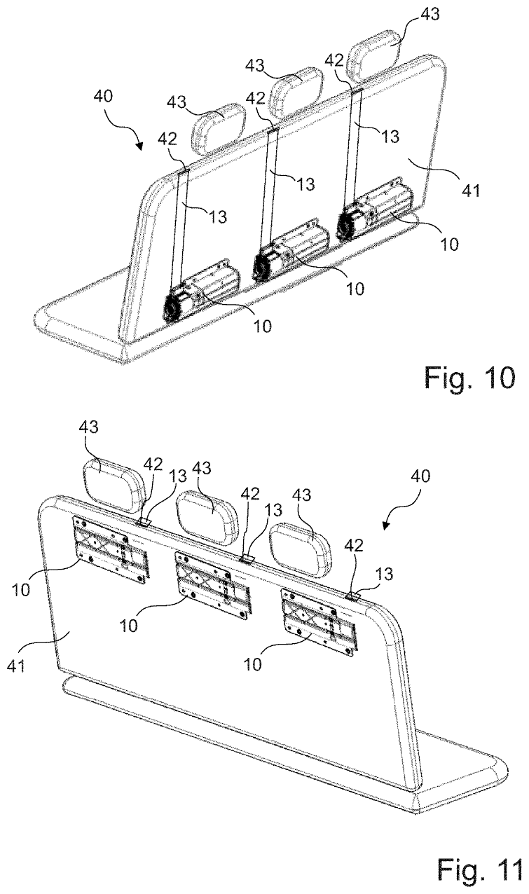

FIG. 10 shows a vehicle seat in the form of a vehicle bench seat having three seats and three seatbelt retractors mounted on the backrest at pelvic height; and

FIG. 11 shows a vehicle seat in the form of a vehicle bench seat having three seats and three seatbelt retractors mounted in the backrest.

FIG. 1 is a front view of an advantageous embodiment of a seatbelt retractor 10. The seatbelt retractor 10 has a belt shaft 12 (shown schematically) which is mounted so as to be rotatable about an axis of rotation 25 and which is arranged in a housing 11 together with the other functional modules 35 of the seatbelt retractor 10, such as blocking elements, seatbelt tensioners, etc. The housing 11 has two housing halves 16, 17, the illustration in FIG. 1 showing the front housing half 16, which is shell-shaped. The rear housing half 17 is shown in the rear view of the seatbelt retractor 10 in FIG. 2 and is designed like a cover. The front housing half 16 has a bead 36 that extends in parallel with the axis of rotation 25 of the belt shaft 12 and also a mounting portion 22 that overlaps with the rear housing half 17 at the top and bottom, which is connected in this advantageous embodiment by four rivet nuts 18. In addition to mechanically connecting the two housing halves 16, 17, the rivet nuts 18 also serve as securing projections 15 for securing the seatbelt retractor 10 to a vehicle seat 40; see also FIGS. 6 to 11.

As can be seen in FIG. 2, the rivet nuts 18 are arranged in a common securing plane 21. As a result, the rivet nuts 18 or the securing projections 15 can be mounted particularly advantageously on flat regions of a vehicle seat 40. In this advantageous embodiment, the housing half 17 has two beads 36 extending in parallel with the axis of rotation 25 of the belt shaft 24. Between these beads 36, two pairs of intersecting beads 37 are arranged, each of which is at an angle, for example in the range of 20° to 70°, with respect to the beads 36.

A seatbelt 13 is arranged on the belt winding 12 and is guided out of the seatbelt retractor 10 in an exit direction 20. In this advantageous embodiment, the seatbelt 13 is guided by a plastics belt guiding element 19, which has an outlet opening 14 through which the seatbelt 13 is guided out of the seatbelt retractor 10.

FIG. 3 is an exploded view of the housing 11 comprising the two housing halves 16 and 17. Furthermore, the four rivet nuts 18 are shown, which can be inserted from the back of the seatbelt retractor 10, from the side of the housing half 17, into the mounting portions 22 or into the edges of the housing halves 16, 17.

As can be seen in the exploded view in FIG. 3, the two housing halves 16, 17 form a cuboidal interior 28 which extends along the axis of rotation 25. The interior 28 is formed by the interior portions 24 of the two housing halves 16, 17. In the region of the belt shaft 12, on which the seatbelt 13 can be wound up to form a belt winding 26, the interior portions 24 of both housing halves 16, 17 have partially cylindrical bulges 27 which are adapted to the cylindrical shape of the belt winding 26.

Furthermore, in this advantageous embodiment, the housing 11 comprises three bearing plates 29, 30, 31, wherein two bearing plates 29, 30 are arranged on both sides of the belt winding 26 and close off both sides of a belt winding chamber 32 axially along the axis of rotation 25 of the belt shaft 12. The bearing plate 30 divides the interior 28 of the seatbelt retractor 10 into a belt winding chamber 32 and a functional chamber 33, in which, for example, a belt tensioner and/or additional functional modules 35 which can act on the belt shaft 12 can be arranged. The functional chamber 33 is axially closed off by the bearing plate 31.

FIG. 4 shows an exploded view comprising a housing 11, in which the two housing halves 16, 17 are joined using four rivet nuts 18, and a belt guiding element 19. As can be seen in FIG. 4, the belt guiding element 19 has lateral guides 23 on both sides, with which the belt guiding element 19 can be inserted into the housing 11 perpendicularly to the exit direction 20 in this advantageous embodiment. The belt guiding element 19 comprises the outlet opening 14 through which the seatbelt 13 is guided when mounted.

In possible embodiments, in addition to being connected by the rivet nuts 18, the two housing halves 16, 17 are connected, for example, by press joints or clinch connections, which are preferably also arranged in the over-lapping mounting portion 22 of the two housing halves 16, 17.

FIG. 5 shows the embodiment of the seatbelt retractor 10 in FIG. 1 to 4 in a modified form, wherein the mounting portion 22 of the housing 11 has interruptions 34.

FIGS. 6 to 11 show embodiments of vehicle seats 40, each of which comprises seatbelt retractors 10 proposed on the backrest 41.

FIG. 6 shows, for example, an embodiment of a vehicle seat 40 comprising a seatbelt retractor 10 which is secured to the backrest 41 by means of the rivet nuts 18. The seatbelt retractor 10 is mounted on the backrest 41 approximately at an occupant's chest height. In this embodiment, the seatbelt retractor 10 is therefore not mounted at the upper end of the backrest 41. The seatbelt 13, which exits the outlet opening 14 of the seatbelt retractor 10 upward in the direction of the headrest 43, runs in parallel with the backrest 41 up to a seatbelt deflector 42, which is arranged in the upper region of the backrest 41. The seatbelt deflector 42 therefore guides the seatbelt 13 to the front part of the backrest 41 so that the seatbelt 13 can be fastened by an occupant. The seatbelt 13 can, for example, be covered by an additional cover.

FIG. 7 shows a further embodiment of a vehicle seat 40 in which, in contrast to the embodiment in FIG. 6, the seatbelt retractor 10 is arranged in the lower region of the backrest 41 at the level of an occupant's pelvis. In this embodiment, the distance between the seatbelt retractor 10 and the seatbelt deflector 42 is significantly increased so that the seatbelt 13 is guided in parallel with the backrest 41 over a longer portion, for example of more than 40 cm.

FIG. 8 shows a further advantageous embodiment of a vehicle seat 40 comprising a seatbelt retractor 10. In contrast to the embodiments in FIGS. 6 and 7, the seatbelt retractor 10 is secured in a different orientation in the vehicle seat 40 so that the housing 11 of the seatbelt retractor 10 extends from the securing projections 15 and into the backrest 31.

FIG. 9 shows an advantageous embodiment of a vehicle seat 40 comprising three seats next to one another on a common bench seat. Similarly to the embodiment in FIG. 6, three seatbelt retractors 10 are mounted next to one another on the backrest 41 in the upper region of the backrest 41, approximately at an occupant's chest height. Accordingly, the three seat-belts 13 are guided to three seatbelt deflectors 42 of the backrest 41.

FIG. 10 shows a further embodiment of a vehicle seat 40 comprising three seats next to one another on a common bench seat having a common backrest 41. In contrast to the embodiment in FIG. 9, the seatbelt retractors 10 are each arranged on the vehicle seat 40 at a greater distance from the seatbelt deflectors 42. Accordingly, the embodiment in FIG. 10 is analogous to the embodiment in FIG. 7 with only one seat on the vehicle seat 40.

A further possible embodiment of a vehicle seat 40 is shown in FIG. 11, which, in contrast to the embodiment in FIG. 8, has three seats for occupants arranged next to one another, which correspondingly comprise three seatbelt retractors 10 arranged on the backrest 41.

1. A seatbelt retractor for securing in and/or on a backrest of a vehicle seat, wherein the seatbelt retractor has a housing in which a belt shaft is rotatably mounted about an axis of rotation, on which belt shaft a seatbelt of the seatbelt retractor can be wound into a cylindrical belt winding, wherein the housing comprises two housing halves which at least partially radially surround the belt winding wherein at least one further functional module of the seatbelt retractor is arranged in the housing along the axis of rotation of the belt shaft, preferably coaxially to the axis of rotation.

2. The seatbelt retractor according to claim 1, wherein at least one housing half, has, radially towards the outside, at least one partially cylindrical bulge adapted to the belt winding

3. The seatbelt retractor according to claim 2, wherein the housing forms a cuboidal interior which is enlarged by the bulges.

4. The seatbelt retractor according to claim 1, wherein the seatbelt retractor has a bearing plate on both sides of the belt winding along the axis of rotation each of which bearing plates engages in at least one housing half,

5. The seatbelt retractor according to claim 4, wherein one of the bearing plates divides the interior of the housing into a belt winding chamber and a functional chamber, wherein the belt winding chamber and the functional chamber are arranged one behind the other along the axis of rotation of the belt shaft.

6. The seatbelt retractor according to claim 1, wherein the housing has beads extending in parallel with the axis of rotation of the belt shaft.

7. The seatbelt retractor according to claim 1, wherein the housing has beads arranged in a cross shape, preferably in the region of the functional chamber.

8. The seatbelt retractor according to claim 1, wherein the housing has mounting portions and interior portions which form an interior wherein the mounting portions are flat and adjoin parts of the interior portions

9. The seatbelt retractor according to claim 8, wherein the mounting portions lie in a common securing plane

10. The seatbelt retractor according to claim 9, wherein the mounting portions lie in the securing plane together with an interior portion

11. The seatbelt retractor according to claim 8, wherein the mounting portions are formed in one layer from one housing half or in two layers from two housing halves

12. The seatbelt retractor according to claim 8, wherein the mounting portions have at least one interruption along the axis of rotation of the belt shaft

13. The seatbelt retractor according to claim 8, wherein an upper mounting portion is arranged above the interior portion and a lower mounting portion is arranged below the interior portion, wherein the lower mounting portion is wider than the upper mounting portion

14. The seatbelt retractor according to claim 1, wherein the seatbelt is guided out of the seatbelt retractor through an outlet opening, wherein at least three securing projections are provided in the mounting portions on the housing of the seatbelt retractor for securing in and/or on a backrest of a vehicle seat.

15. A vehicle seat comprising a seatbelt retractor according to claim 1, wherein the vehicle seat has a backrest wherein the seatbelt retractor is secured in and/or on the backrest.

16. The vehicle seat according to claim 15, wherein the seatbelt retractor is arranged in and/or on the backrest in the chest region or the seatbelt retractor is arranged in and/or on the backrest in the pelvic region.

17. The vehicle seat according to claim 15, wherein three seatbelt retractors are arranged next to one another on a backrest for three occupants.

18. The vehicle seat according to claim 15, wherein that the housing extends at least over half the width of the backrest of the vehicle seat.
